(19) United States
(12) Patent Application Publication
(10) Pub. No.: US 2016/0113829 A1
(43) Pub. Date: Apr. 28, 2016

(54) Method & Device for Containing Deadly Germs of a Patient During Treatment

(71) Applicants: Adele Lenore Poenisch, Berkeley, CA (US); Kenneth Matsumura, Berkeley, CA (US)

(72) Inventors: Adele Lenore Poenisch, Berkeley, CA (US); Kenneth Matsumura, Berkeley, CA (US)

(21) Appl. No.: 14/121,861

(22) Filed: Oct. 28, 2014

(51) Int. Cl. A61G 10/00; A61G 10/02

(52) U.S. Cl. CPC A61G 10/005; A61G 10/02; A61G 2200/327

(57) ABSTRACT

A method and device is presented for a hermetically sealed human sized, largely rectangular, mostly transparent, preferably hard-shelled, multi-gloved containment box that can hold a patient and which has means to allow the patient treatments by caregivers outside said box without caregiver having any direct contact with said patient.

### BACKGROUND OF INVENTION

This invention is in the field of method for germ containment and more specifically a method for preventing the spread of deadly germs from a sick patient while being treated.

Recent decades have seen deadly viruses such as ebola and SARS threaten the decimation of our society. Given the fact that there exists hospital beds for less than 1% of our population to contain and treat such deadly viruses, with doubts that enough nurses can be trained to not catch the virus from a patient should a viral epidemic occur, it behooves society to have zero tolerance for allowing patients to spread the virus into the society through caregivers.

Current method for containing the virus involves specialized rooms where air coming out is filtered, caregivers don gowns, headgear, masks, and shoe covers which must be carefully removed when coming out of the room, typically in an ante-room, being careful not to touch infected gear with bare hands. When such a system is applied suddenly in untrained facility involving more than 70 care personnel of varying background in education, failures do occur. Also, such a set up requires a large amount of space that must be set up in advance. Such a space may not find other uses when not in use which can be costly to create and costly to let sit idle. Society is in need of a more sure-proof, economical method of containment that can also lend itself to massive scaling up of the number of patients such as can occur in bio-terrorism. Such a method ideally could take an ordinary room, not even in the hospital, to treat sick patients.

### DRAWINGS OF INVENTION

FIG. 1 generally depicts basic aspects of the invention.

### SUMMARY OF INVENTION

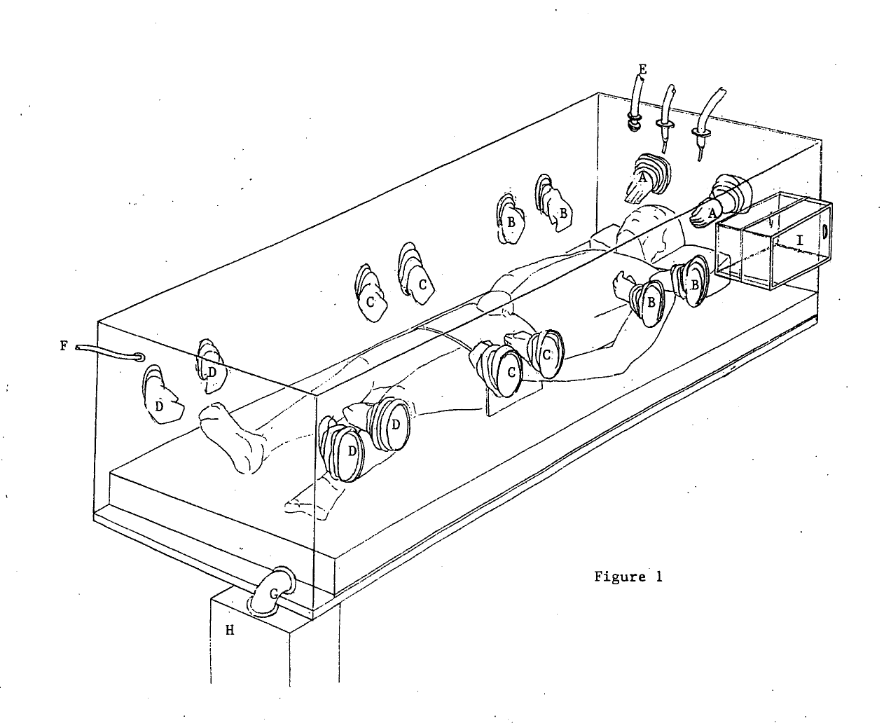

Generally, our method of this invention involves a hermetically sealed human sized, largely rectangular, mostly transparent, preferably hard-shelled, multi-gloved containment box (FIG. 1) that can hold a patient and which has means to allow the patient treatments by caregivers outside said box without caregivers having any direct contact with said patient. Said means would include dual-gloved portals in the box at the end wall close to the head of the patient that would allow the patient to be intubated or to receive nasal suction or to allow insertion of nasogastric tubes (FIG. 1, A). A second set of dual-gloved portal means on the side walls near the patient's right and left upper arms would allow venipuncture of patient for tests and would allow venous catheterization so that the patient can be given intravenous fluids, medications and nourishment (FIG. 1, B). Another dual-gloved portal means on the right and left side walls at the hip level would allow caregivers to tap the femoral artery for blood gases, do a lumbar puncture, or catheterize the bladder of the patient (FIG. 1, C). Further additional dual-gloved portal means at the level of the patient's ankle (FIG. 1, D) would allow venipuncture as well allow starting intravenous catheters there. All said dual glove portal means would allow caregivers to touch the patient through gloved hands to comfort the patient. Other means are provided to supply other necessary services a patient would need including air, fluids, nourishment, hygiene, general comfort.

### DETAILED DESCRIPTION OF INVENTION

### Sealed Box

Said box could be rectangular to facilitate storage of a large number of them when not in use, but could be of other dimensions to allow patients greater mobility and position by themselves. Said box could have rounded corners. Therefor, said box can be termed a sealed vessel instead of box. Said box in a preferred embodiment is made of hard plastic, such as plexiglass or polycarbonate for greater strength and durability.

### Dual Glove Portal Means

By the term, “dual gloved portal means” we mean something like what is shown at websites such as www.glovebox.com or www.germfree.com. It will be important that no one with long finger nails or jewelry be allowed to reach into said gloves. We also recommend that caregivers wear double disposable gloves before inserting hands into the gloves of said box.

### Interior Environment of Box

Said sealed box has means to allow flow of oxygen and/or air into the box (FIG. 1, E) without allowing germs inside the box to leave the box. Said sealed box has means for the egress of the used air (FIG. 1, F) to come out of the box without allowing germs to enter the outer environment of the box. Means are provided to sterilize egress air by such methods as heat, ultraviolet ray, bubbling through germ-killing liquid, or other means before the air is allowed to enter the outer environment.

Said box has means to maintain a slight negative air pressure in respect to the box's interior environment to reduce any chance of germ inside the box escaping into the outer environment. Said box has associated means for regulating interior humidity.

### Privacy

Said box is mostly transparent to facilitate patient care, but where patient is not fully gowned, means are provided to provide privacy at least to the genital area and to the breast area for female patients. Such means may be simply be a curved cover held away from direct contact with the patient. There is now light changing window glass that could be used to make areas of the box less transparent.

### Heat

Said box has means to regulate the inside temperature of said box by such means as a heated bed surface and/or by using heated air pumped into said box.

### Decubitus (Bedsore) Prevention

Said box has means to prevent bed sores by the use of standard anti-decubitus air mattresses.

### Physical Therapy Option

In a preferred embodiment, said box has inside a manually operated exercise bar which uses resistance to exercise the patient's major limbs.

### Lighting

In a preferred embodiment said box can have its own light source for patient's benefit (for example, to read a book) or caregiver's benefit although it may be preferable to provide light from outside the box.

### Caregiving Features

### General

Said box can be placed on a mechanized flat surface that can tilt the head or foot of the box or the left or the right side of the box and such mechanism can be a part of the underside of said box. Said box has means to restrain or support the patient during this process so they do not slide off the mattress. Such tilting allows the patient to be showered and dirty water to be drained out (FIG. 1, G) or to wash away from the patient any fecal matter or urine on the mattress.

### Waste Management

Said sealed box has efficient-means to disinfect liquid or solid waste of the patient and other used products coming out of said box, by chlorine or other disinfectant, by autoclaving, or by heat.

In one preferred embodiment, said box has incinerator means (FIG. 1, H) close to said box so that soiled linen and other infected products of care-giving can be passed into said incinerator means without such product releasing germs outside said box. Such incinerator means shall have means to prevent noxious fumes from incineration from entering said box or the environment outside the box.

In another preferred embodiment, said box has a hole under the buttock of the patient to drain away fecal material into a collection container which empties into such incineration means, all ensuring that no germs are allowed to escape out of the box into the outer environment.

Another preferred embodiment of said box has means to disinfect products of caregiving by allowing such products to be passed into a container outside the box that holds chlorine or other disinfectants in such a manner as to not allow germs on the products to escape into the environment outside said box. Provisions are provided to prevent noxious fumes of disinfectant from getting into said box holding a patient.

### Providing of Food & Supplies

Said box has means to allow equipment, supplies, and medication to be inserted into the box without any significant potential of infected air inside said box from escaping into the room that holds said box.

In a preferred embodiment of said box, samples of blood, urine and other bodily excretions can be removed through portal means after tubes holding such samples are dipped first in a disinfectant and passed out through said portal means. Said portal means (FIG. 1, I) uses an intermediary “airlock” chamber attached to said box with an air-tight door from said chamber to said box interior and a second air-tight door from said chamber to the environment outside said box. It will be obvious to those skilled in the art how to decontaminate the interior of the chamber in between each use, such as with disinfectant wash fluid or disinfectant gas. Food and other medical supplies can be placed into said chamber and exterior door closed air-tight. Subsequently, an operator can reach into the interior of said box using glove portal means to open the door separating said chamber from the interior of said box, grab any item placed into said chamber and place the item inside said box. The operator then closes the interior door to said chamber, after which said chamber is disinfected for the next use.

Said box has means to allow intravenous tubings connected to intravenous fluids hanging outside said box into said box through ports designed to not allow germs to come out of said box. Design of such port means is obvious to those skilled in the art, but can include such means as a rubber plug with a slit that allows an intravenous tubing to be passed into the interior of said box. Said box has similar means to allow respirator tubing connected to a respirator unit outside said box to enter said box through ports designed to not allow germs to come out of said box. It may be an operational provision to not permit any tubing that entered said box to not come back out of said box except through means described above under Waste Management. Similarly, said box can have means to allow a warm water hose to enter said box without allowing any germ inside the box to come outside, said hose then being usable to provide shower to the patient.

### Placement of Patient into Box

Means are provided for placing a patient into said box. In a preferred embodiment, the wall of said box nearest the head of patient to be placed into said box is hinged to open to allow a patient to be slid into said box, said hinged wall serving as a door being made to close air-tight and locking it shut ensuring no accidental opening that can allow germs from inside said box to escape into the

Having described the best embodiments of our inventions, we claim:

1. A hermetically sealed, rectangular substantially transparent box large enough to hold an infected human to be medically treated without contaminating caregivers or the environment outside said box having means for placing said human sealed inside and removing said human from said box, means for multiple dual-gloved portals for handling said human from outside, means for anti-decubitus mattress, means for inputting respiratory gases into said vessel, means for maintaining optimum humidity inside said vessel, means for allowing egress of expired gases from said vessel, means for placing and removing objects into and out of said vessel in a sterile manner, means for providing fluids and nourishment to said human, means for evacuation of waste products from said human without contaminating said caregivers or said environment, and means to regulate temperature within said vessel, all said means ensured to not allow germs inside said box to escape outside said box.
